(19) United States
(12) Patent Application Publication
(10) Pub. No.: US 2026/0275996 A1
(43) Pub. Date: Sep. 17, 2026

(54) SEALING SYSTEM FOR HVAC&R SYSTEM

(71) Applicant: Tyco Fire & Security GmbH, Neuhausen am Rheinfall (CH)

(72) Inventors: Francois Charles Andre Clunet, La Chapelle-Sur-Erdre (FR); Damien Jean Daniel Arnou, La Séguinière (FR); Paul Eric Le Sausse, Nantes (FR); Abdel Kader Jannoun, Severac (FR)

(21) Appl. No.: 19/167,141

(22) PCT Filed: Mar. 21, 2024
(86) PCT No.: PCT/EP2024/057612

§ 371 Date: Sep. 19, 2025

Related U.S. Application Data
(60) Provisional application No. 63/453,682, filed on Mar. 21, 2023.

(51) Int. Cl. F04D 29/14; F04D 17/10; F04D 25/06; F04D 29/42; F25B 31/00; F25B 31/02

(52) U.S. Cl. CPC F04D 29/143; F04D 17/10; F04D 25/06; F04D 29/4206; F25B 31/006; F25B 31/026

(57) ABSTRACT

A compressor system includes a housing having an impeller disposed therein, a motor disposed within the housing, and a sealing system disposed within the housing. The motor includes a rotor shaft coupled to the impeller, and the motor is configured to drive rotation of the rotor shaft and the impeller. The sealing system includes a sealing element circumferentially disposed around the rotor shaft and configured to bias against a surface of the rotor shaft in a first configuration. The housing includes an injection port formed therein, the injection port is configured to direct a pressurized fluid into the housing to impinge against the sealing element to transition the sealing element from the first configuration to a second configuration, and the sealing element is lifted away from the surface of the rotor shaft in the second configuration.

### CROSS-REFERENCE TO RELATED APPLICATIONS

This application claims priority from and the benefit of U.S. Provisional Application No. 63/453,682, entitled “SEALING SYSTEM FOR HVAC&R SYSTEM,” filed Mar. 21, 2023, which is herein incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, air conditioning, and refrigeration (HVAC&R) systems, or vapor compression systems, are utilized in residential, commercial, and industrial environments to control environmental properties, such as temperature and humidity, for occupants of the respective environments. The HVAC&R system circulates a working fluid (e.g., refrigerant), which changes phases between vapor, liquid, and combinations thereof in response to exposure to different temperatures and pressures associated with operation of the HVAC&R system. For example, the HVAC&R system utilizes one or more compressors to circulate the working fluid to a heat exchanger which may transfer heat between the working fluid and another fluid (e.g., cooling fluid) flowing through the heat exchanger. In some applications, a motor that powers the compressor(s) may include rotating components that operate to rotate an impeller of the compressor(s), thereby enabling the compressor(s) to compress the working fluid and deliver the working fluid to other components of the vapor compression system. A cooling system is typically utilized to cool the motor during operation of the HVAC&R system.

Unfortunately, existing compressors, motors, and motor cooling systems are susceptible to various inefficiencies that may reduce efficiency of the HVAC&R system and/or may reduce a useful life of components of the HVAC&R system.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a compressor system includes a housing having an impeller disposed therein, a motor disposed within the housing, and a sealing system disposed within the housing. The motor includes a rotor shaft coupled to the impeller, and the motor is configured to drive rotation of the rotor shaft and the impeller. The sealing system includes a sealing element circumferentially disposed around the rotor shaft and configured to bias against a surface of the rotor shaft in a first configuration. The housing includes an injection port formed therein, the injection port is configured to direct a pressurized fluid into the housing to impinge against the sealing element to transition the sealing element from the first configuration to a second configuration, and the sealing element is lifted away from the surface of the rotor shaft in the second configuration.

In an embodiment, a heating, ventilation, air conditioning, and refrigeration (HVAC&R) system includes a compressor configured to compress a working fluid and circulate the working fluid through a working fluid circuit, a motor coupled to the compressor via a rotor shaft and configured to drive operation of the compressor via rotation of the rotor shaft, and a sealing system configured to limit fluid migration between the motor and the compressor. The sealing system includes a sealing element configured to transition from a first configuration to a second configuration based on operation of a pressurized fluid source fluidly coupled to the sealing element, a sealing portion of the sealing element is configured to engage with a surface of the rotor shaft in the first configuration, and the sealing portion of the sealing element is configured to disengage from a surface of the rotor shaft in the second configuration.

In an embodiment, a sealing system for a motor of a compressor includes a sealing element circumferentially disposed around a rotor shaft of the motor and configured to transition between a first configuration and a second configuration. The sealing element includes a sealing portion configured to disengage from an outer surface of the rotor shaft in the first configuration and contact the outer surface of the rotor shaft in the second configuration. The sealing system further includes a pressurized fluid source configured to provide a pressurized fluid, and the sealing element is configured to transition from the second configuration to the first configuration in response to the pressurized fluid source providing the pressurized fluid. The sealing system further includes a controller configured to control operation of the pressurized fluid source to transition the sealing element between the first configuration and the second configuration in response to a detected operational state of the compressor.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building that may utilize a heating, ventilating, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of a vapor compression system, in accordance with an aspect of the present disclosure;

FIG. 4 is a schematic of an embodiment of a vapor compression system, in accordance with an aspect of the present disclosure;

FIG. 5 is a cross-sectional side view of an embodiment of a compressor of a vapor compression system, illustrating a motor and a sealing system of the compressor, in accordance with an aspect of the present disclosure;

FIG. 6 is a cross-sectional side view of a portion of an embodiment of a compressor, illustrating a sealing system for a motor of the compressor, in accordance with an aspect of the present disclosure;

FIG. 7A is a cross-sectional side view schematic of an embodiment of a sealing system for a motor of a compressor during operation of the compressor, in accordance with an aspect of the present disclosure;

FIG. 7B is a cross-sectional side view schematic of an embodiment of a sealing system for a motor of a compressor during non-operation of the compressor, in accordance with an aspect of the present disclosure; and

FIG. 8 is a cross-sectional side view of a portion of an embodiment of a compressor, illustrating a sealing system for a motor of the compressor, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

As briefly discussed above, a heating, ventilation, air conditioning, and/or refrigeration (HVAC&R) system may be configured to operate to satisfy heating and/or cooling demands within a building, home, or other suitable structure. For example, the HVAC&R system may include a vapor compression system (e.g., a chiller system, heat pump system) that transfers thermal energy between a working fluid (e.g., water, refrigerant, heat transfer fluid) and a fluid to be conditioned (e.g., air, water, or brine). In some embodiments, the working fluid and the fluid to be conditioned may be the same fluid (e.g., water). The vapor compression system may include one or more vapor compression circuits (e.g., heat pumps) that each include one or more heat exchangers, such as a condenser and an evaporator that are fluidly coupled to one another via one or more conduits (e.g., vapor compression circuit, working fluid circuit, refrigeration circuit). Further, each vapor compression circuit may include a compressor configured to pressurize and circulate the working fluid through the conduit and, thus, enable the transfer of thermal energy between the working fluid and the fluid to be conditioned via the one or more heat exchangers. To facilitate different operating modes, the vapor compression system may include several controllable features or components, such as valves, expansion devices, a coil fan, a condenser pump, and/or an evaporator pump. The vapor compression system may include a controller configured to determine the mode of operation of the vapor compression system and to control the valves, expansion devices, pumps, and fan to operate the vapor compression system in the desired mode. In certain embodiments, the vapor compression system may be a heat pump system configured to facilitate a flow of working fluid (e.g., water) through the vapor compression circuit in different directions for different operating modes. In other embodiments, the working fluid may flow through the vapor compression circuit in the same direction during multiple (e.g., all) modes of operation.

The compressor (e.g., centrifugal compressor) of a vapor compression system (e.g., a heat pump system) may be designed for certain operating conditions, which may be related to one or more characteristics or parameters of the working fluid (e.g., refrigerant, water). For example, compressors may be designed and/or selected for implementation in the HVAC&R system based on a type of the working fluid, working fluid flow (e.g., flow rate), working fluid temperature and pressure conditions at a suction inlet of the compressor, and/or working fluid temperature and pressure conditions at a discharge outlet of the compressor.

In certain HVAC&R systems, water may be utilized as a working fluid, and the compressor of the vapor compression system (e.g., heat pump system) may be configured to operate to circulate and/or compress the water (e.g., steam) through the working fluid circuit (e.g., through one or more heat exchangers) to provide a heat exchange relationship with another fluid (e.g., cooling fluid, air, brine, etc.) directed across the heat exchangers of the working fluid circuit. Alternatively, the HVAC&R system may be configured to circulate and/or compress the water (e.g., steam) to provide a heat exchange relationship with another flow of the water. In some embodiments in which the compressor is configured to circulate water as a working fluid, vaporized water (e.g., steam) may be directed from an evaporator to the compressor, thereby enabling the compressor to compress the steam before delivering the steam to a condenser. The compressor may be coupled to a motor configured to drive or power the compressor. For example, the motor may include a rotor shaft supported by a bearing assembly within a motor housing. By rotating the rotor shaft, the motor enables rotation of a rotor of the compressor coupled to the rotor shaft to drive the working fluid (e.g., water) within the working fluid circuit. However, to adequately drive the water through the working fluid circuit at a desired operating pressure and/or flow rate, the compressor may be configured to operate at high speeds during an operative mode of the compressor. Furthermore, during an idle or standby mode of the compressor, working fluid (e.g., water, steam) remaining within the compressor may condense, thereby creating a negative pressure or vacuum on a compression side (e.g., impeller side, compression cavity, working fluid flow path) of the compressor. In certain cases, air (e.g., non-condensable air) from the motor may be drawn into (e.g., entrained into) the compression side of the compressor by the negative pressure vacuum. Typically, non-condensable air on the compression side of the compressor is purged before the compressor is operated again, which causes a reduction in efficiency. Additionally, the air may include oxygen, which may cause wear and degradation (e.g., oxidation as a result of the oxygen within the entrained air) on components of the compressor, which is undesirable. Further still, in some conditions, condensed working fluid on the compression side of the compressor may flow into the motor housing, thereby causing wear and degradation on components of the motor, which may also be undesirable.

Accordingly, embodiments of the present disclosure are directed toward a sealing system (e.g., lip seal system, dovetail seal system) having one or more liftable and/or radially-adjustable sealing elements that enable operation of the compressor at high speeds during an operative mode of the compressor, while limiting an amount of fluid migration between different portions of the compressor. In particular, the sealing system is configured to block flow of fluid (e.g., air) from the motor cavity to a compression side (e.g., impeller side, compression cavity, working fluid flow path) of the compressor and to block flow of working fluid (e.g., condensed working fluid, water, steam) from the compression side to the motor cavity during an idle or standby mode (e.g., non-operating mode) of the compressor. For example, present embodiments are directed to a sealing system having one or more sealing elements, where at least one of the one or more sealing elements is fluidly coupled to (e.g., exposed to) a pressurized fluid source and configured to transition between a first configuration (e.g., disengaged configuration), in which the sealing element is not engaged with the rotor shaft, and a second configuration (e.g., engaged configuration), in which the sealing element engages with (e.g., contacts) an outer surface of the rotor shaft to provide a fluid seal between the motor cavity and the compression side of the compressor.

For example, during an operative mode of the compressor (e.g., active operating mode, operational state, active state, compressing state), a pressurized fluid (e.g., gas buffer, steam buffer) may be directed through a conduit (e.g., injection pathway, injection port, pressurized fluid port) and toward the sealing element. As the pressurized fluid engages with the sealing element, the sealing element may be biased away (e.g., lift away, disengage, radially lift) from the surface of the rotor shaft by the pressurized fluid. By directing the pressurized fluid toward the sealing element during operation of the compressor to disengage the sealing element from the rotor shaft, increased speeds of the rotor shaft may be more readily and desirably achievable as an amount of interference (e.g., friction) from the sealing element on the rotor shaft is reduced. Additionally, as the pressurized fluid impinging against the sealing element causes the sealing element to disengage from the rotor shaft, the pressurized fluid may also limit an amount (e.g., a flow) of air within the motor cavity from entering into the compression side during an operative mode of the compressor. For example, the pressure, force, and/or flow of the pressurized fluid directed toward the sealing element may be greater than a pressure of the air present within the motor cavity. Thus, as the pressurized fluid is directed past (e.g., across, through) the sealing element, the flow of pressurized fluid may limit flow of air from the motor cavity and toward (e.g., into) the compression side of the compressor (e.g., traveling in a direction against the flow of the pressurized fluid).

During an idle or standby mode of the compressor (e.g., non-operating mode, inoperative mode, inactive state), the pressurized fluid may no longer be directed toward the sealing element, thereby enabling the sealing element to reengage with the rotor shaft to form a fluid seal. For example, the sealing element may be configured to engage with (e.g., contact) an outer surface of the rotor shaft to provide a fluid seal between the motor cavity and the compression side in a resting state (e.g., a state and/or condition in which no pressurized fluid is directed toward the one or more sealing elements) of the sealing element. As noted above, during an idle mode of the compressor, working fluid (e.g., water, steam) may condense within the compressor (e.g., on the compression side), and in certain cases, may naturally tend to migrate toward the motor housing (e.g., motor cavity), which may be undesirable. Additionally, as the working fluid condenses, a negative pressure vacuum may be created on the compression side, which may cause non-condensable air from the motor to be drawn toward the compression side by the negative pressure vacuum generated on the compression side of the system, which may also be undesirable. Thus, by employing a sealing system having one or more sealing elements that are configured to engage with a rotor shaft during a resting state of the one or more sealing elements and during non-operation of the compressor, fluid migration between various components of the compressor (e.g., between the compression side and the motor cavity) may be reduced, thereby increasing efficiency and reducing costs associated with wear and degradation of components of the HVAC&R system.

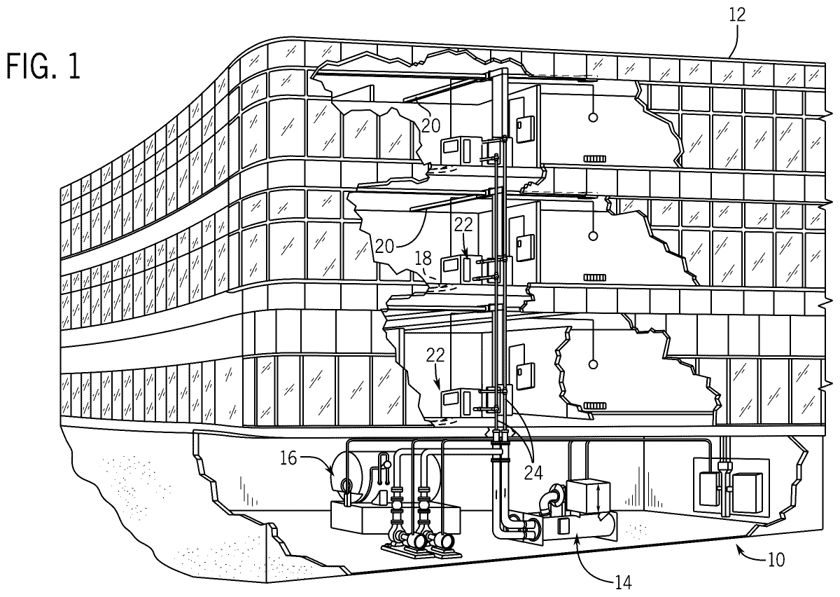

Turning now to the drawings, FIG. 1 is a perspective view of an embodiment of an environment for a heating, ventilation, air conditioning, and refrigeration (HVAC&R) system 10 in a building 12 for a typical commercial setting. The HVAC&R system 10 may include a vapor compression system 14 (e.g., chiller system, heat pump system) that supplies a chilled liquid, which may be used to cool the building 12. The HVAC&R system 10 may also include a boiler 16 to supply warm liquid to heat the building 12 and an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or chilled liquid from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

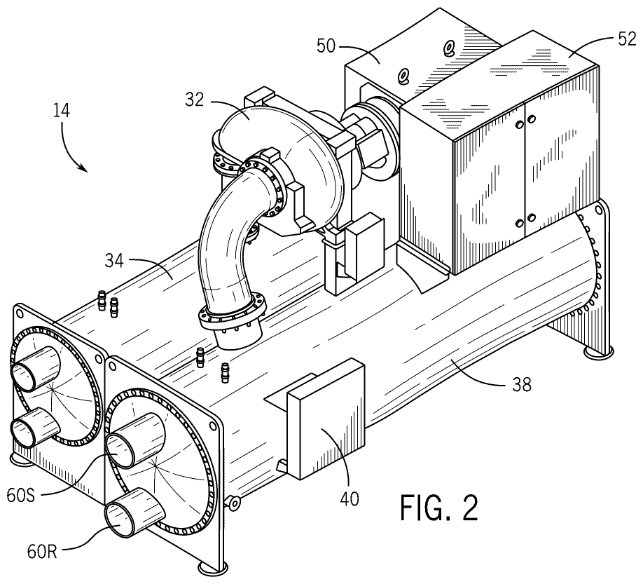

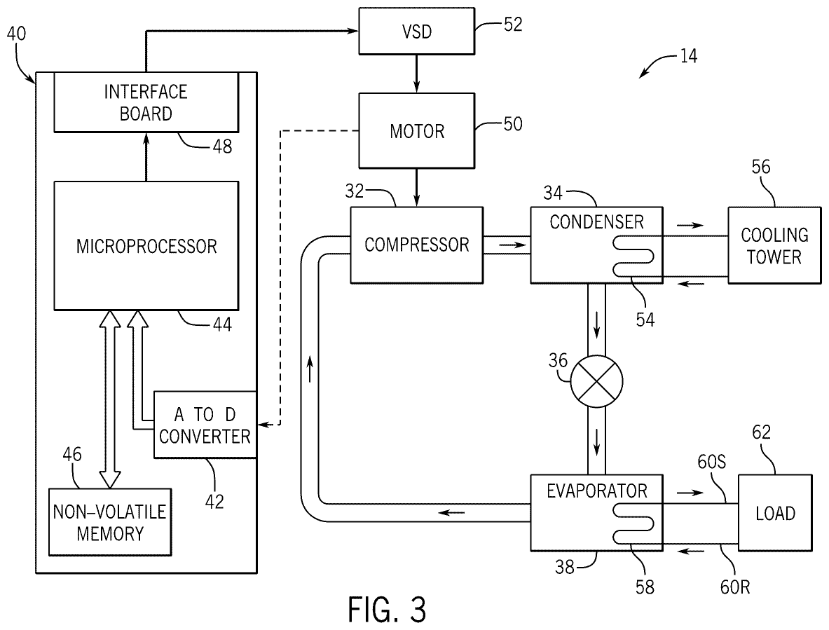

FIGS. 2 and 3 illustrate embodiments of the vapor compression system 14 that can be used in the HVAC&R system 10. The vapor compression system 14 may circulate a working fluid through a circuit starting with a compressor 32. The circuit may also include a condenser 34, an expansion valve(s) or device(s) 36, and a liquid chiller or an evaporator 38. The vapor compression system 14 may further include a control panel 40 that has an analog to digital (A/D) converter 42, a microprocessor 44, a non-volatile memory 46, and/or an interface board 48. Some examples of fluids that may be used as working fluids in the vapor compression system 14 are water (e.g., water vapor), R-718, hydrofluorocarbon (HFC) based refrigerants, for example, R-410A, R-407, R-134a, hydrofluoro olefin (HFO), “natural” refrigerants like ammonia (NH₃), R-717, carbon dioxide (CO₂), R-744, or hydrocarbon based refrigerants, or any other suitable working fluid.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 and may be powered by a variable speed drive (VSD) 52. The VSD 52 receives alternating current (AC) power having a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a working fluid vapor and delivers the vapor to the condenser 34 through a discharge passage. In some embodiments, the compressor 32 may be a centrifugal compressor. The working fluid vapor delivered by the compressor 32 to the condenser 34 may transfer heat to a cooling fluid (e.g., water or air) in the condenser 34. The working fluid vapor may condense to a working fluid liquid in the condenser 34 as a result of thermal heat transfer with the cooling fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser.

The liquid working fluid delivered to the evaporator 38 may absorb heat from another cooling fluid, which may or may not be the same cooling fluid used in the condenser 34. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to a cooling load 62. The cooling fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the cooling fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

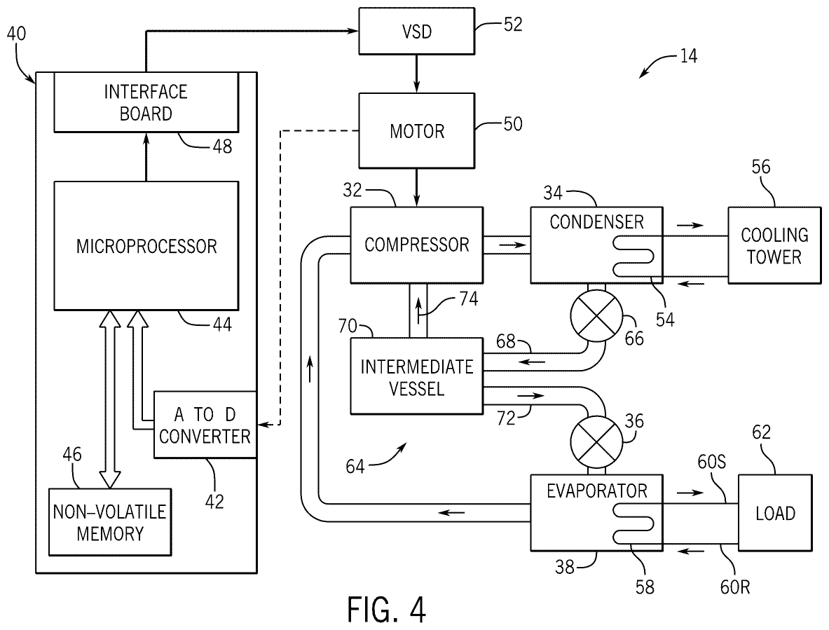

FIG. 4 is a schematic of the vapor compression system 14 with an intermediate circuit 64 incorporated between the condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid may vaporize, and thus, the intermediate vessel 70 may be used to separate the vapor from the liquid received from the first expansion device 66.

Additionally, the intermediate vessel 70 may provide for further expansion of the liquid working fluid due to a pressure drop experienced by the liquid working fluid when entering the intermediate vessel 70 (e.g., due to a rapid increase in volume experienced when entering the intermediate vessel 70). The vapor in the intermediate vessel 70 may be drawn by the compressor 32 through a suction line 74 of the compressor 32. In other embodiments, the vapor in the intermediate vessel may be drawn to an intermediate stage of the compressor 32 (e.g., not the suction stage). The liquid that collects in the intermediate vessel 70 may be at a lower enthalpy than the liquid working fluid exiting the condenser 34 because of the expansion in the expansion device 66 and/or the intermediate vessel 70. The liquid from intermediate vessel 70 may then flow in line 72 through a second expansion device 36 to the evaporator 38.

It should be appreciated that any of the features described herein may be incorporated with the vapor compression system 14 or any other suitable HVAC&R systems. For example, the present techniques may be incorporated with any HVAC&R system having a compressor, such as the compressor 32. The discussion below describes the present techniques incorporated with embodiments of the compressor 32 configured as a single stage compressor. However, it should be noted that the systems and methods described herein may be incorporated with other embodiments of the compressor 32 and the HVAC&R system 10. Further, the present techniques may be incorporated with HVAC&R systems that utilize any suitable working fluid, such as water.

In accordance with the present techniques, motors having rotating components, such as the motor 50 for the compressor 32, may utilize sealing systems to enable operation of the motor 50 and the compressor 32 at high speeds while limiting an amount of fluid migration between a motor cavity of the motor 50 and a compression side (e.g., impeller side, compression cavity, working fluid flow path, compression chamber) of the compressor 32 during an operative mode and/or during an idle or standby mode of the compressor 32. For example, embodiments of the sealing system disclosed herein are configured to block flow of air from the motor cavity of the motor 50 to the compression cavity of the compressor 32 and to block flow of condensed working fluid from the compression cavity of the compressor 32 to the motor cavity of the motor 50.

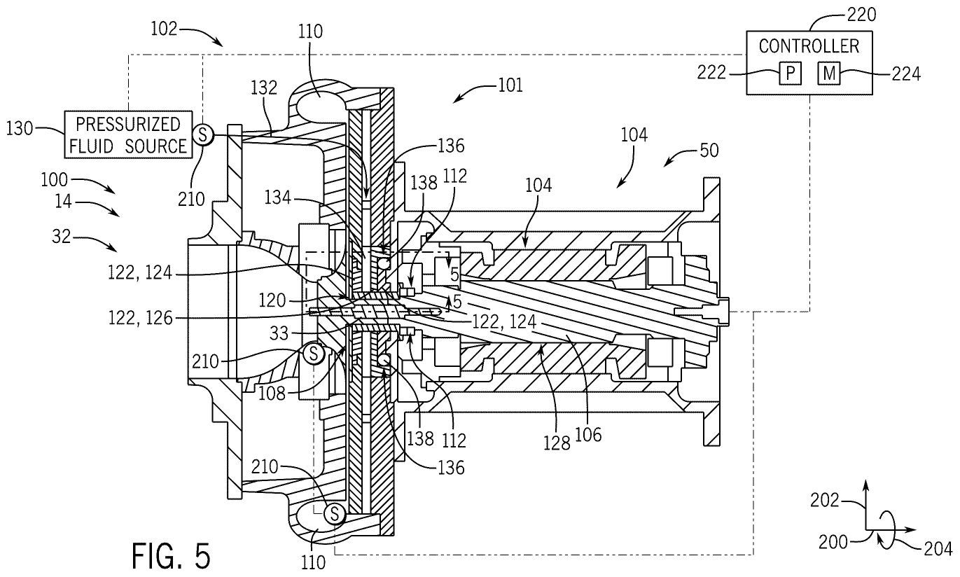

To facilitate the following discussion, FIG. 5 is a cross-sectional side view of a compressor system 100 (e.g., compression section) of the vapor compression system 14 (e.g., heat pump system) having a compressor, such as the compressor 32, and a motor, such as the motor 50 of the vapor compression system 14. In the present embodiment, the compressor system 100 includes a housing 101 (e.g., compressor housing, motor housing, enclosure) configured to contain, enclose, and/or house components of the compressor system 100, such as the motor 50. In some embodiments, the housing 101 may include a compressor housing portion 102 configured to enclose components of the compressor 32 and a motor housing portion 104 configured to enclose components of the motor 50, and the compressor housing portion 102 and the motor housing portion 104 may be coupled (e.g., mounted, secured) to one another. A rotor shaft 106 may be disposed within an interior volume of the motor housing portion 104 and may be coupled to the compressor 32 and configured to drive the compressor 32 as the motor 50 is operated. For example, the rotor shaft 106 may be coupled to an impeller 108 of the compressor 32 via a rotor 33. As the motor 50 is operated, the rotor shaft 106 may be driven into rotation to rotate the impeller 108 of the compressor 32, thereby enabling the compressor 32 to compress a working fluid (e.g., water, steam) to a desired pressure before directing the working fluid out of a volute portion 110 of the compressor 32 and toward downstream components of the vapor compression system 14 (e.g., a heat exchanger, such as a condenser and/or an evaporator) . For example, in embodiments in which the compressor 32 is configured to circulate water as a working fluid, vaporized water (e.g., steam) may be directed from the evaporator 38 to the compressor 32, thereby enabling the compressor 32 to compress the steam before delivering the steam to the condenser 34.

As illustrated, the rotor shaft 106 may be a cylindrical component having a length extending along an axial or longitudinal axis or direction 200, a radius extending along a radial axis or direction 202, and a circumference extending along a circumferential axis or direction 204. The rotor shaft 106 may be supported by one or more bearing assemblies 112, and the bearing assemblies 112 are configured to enable the rotor shaft 106 to rotate about the longitudinal axis 200 relative to the housing 101 to perform work, such as compressing the working fluid (e.g., water, steam). The bearing assemblies 112 may include any suitable bearings circumferentially disposed around the rotor shaft 106, such as ball bearings, sleeve bearings, roller bearings, and so forth.

In certain embodiments, the compressor system 100 of the vapor compression system 14 may include a sealing system 120 (e.g., sealing assembly) configured to enable high speed rotation of the rotor shaft 106, and thus the compressor 32, during an operative mode (e.g., active operating mode, operational state, active state, compressing state) of the compressor 32, and to also enable limited and/or reduced fluid migration between the motor cavity of the motor 50 and the compression side of the compressor 32 (e.g., between the compressor housing portion 102 and the motor housing portion 104) during the operative mode and/or during an idle or standby mode (e.g., non-operating mode, inoperative mode, inactive state) of the compressor 32. For example, the sealing system 120 may include one or more sealing elements 122 (e.g., seals, seal members) configured to engage with the rotor shaft 106 to provide a seal and/or a sealing interface between the motor cavity of the motor 50 and the compression side of the compressor 32 (e.g., between the compressor housing portion 102 and the motor housing portion 104). In certain embodiments, the sealing system 120 may include one or more labyrinth seals 124, such as two labyrinth seals 124 positioned on opposite sides of a lip seal 126 (e.g., with respect to and/or along the longitudinal axis 200). The one or more labyrinth seals 124 may include a sealing extension and a T-shaped cross section with a toothed surface configured to block fluid (e.g., lubricant) flow from the bearing assemblies 112 to the compression side of the compressor 32, configured to block fluid (e.g., non-condensable air) migration from the motor housing portion 104 to the compressor housing portion 102, and/or configured to block fluid (e.g., condensed working fluid [e.g., water]) migration from the compressor housing portion 102 to the motor housing portion 104. The lip seal 126 may be formed from a flexible material, such as polytetrafluoroethylene (PTFE), rubber, or another suitable material that enables the lip seal 126 to be biased against an outer surface 128 of the rotor shaft 106, such as in a resting state (e.g., relaxed state) of the lip seal 126. As such, when the compressor 32 in an idle or standby mode, such as a mode in which the rotor shaft 106 is not driven into rotation, the lip seal 126 may be biased against and/or apply force to the rotor shaft 106, thereby forming a fluid seal that limits migration of fluid from the motor housing portion 104 to the compressor housing portion 102 and/or from the compressor housing portion 102 to the motor housing portion 104.

Additionally, the sealing system 120 includes a pressurized fluid source 130 (e.g., steam buffer source, gas buffer source) that is configured to direct a pressurized fluid 132 (e.g., water, steam, air, gas) toward a back surface (e.g., convex surface, compressor-facing surface, impeller-facing surface) of the lip seal 126 via an injection pathway 134 (e.g., injection passage, injection port) formed (e.g., machined) into the housing 101 (e.g., compressor housing portion 102, motor housing portion 104). As the pressurized fluid 132 impinges against the back surface of the lip seal 126, the pressurized fluid 132 may enable the lip seal 126 to disengage (e.g., lift) from the outer surface 128 of the rotor shaft 106.

Thus, the lip seal 126 may be configured to transition between a first configuration (e.g., disengaged configuration), in which the lip seal 126 is not engaged with the rotor shaft 106 (e.g., when pressurized fluid is directed toward the back surface of the lip seal 126), and a second configuration (e.g., engaged configuration), in which the lip seal 126 engages with (e.g., contacts) the outer surface 128 of the rotor shaft 106 (e.g., when pressurized fluid is not directed toward the lip seal 126) based on operation of the pressurized fluid source 130 (e.g., based on the compressor 32 being in the operative mode or the idle mode), as discussed in greater detail below.

The pressurized fluid source 130 may include a high-pressure or discharge portion of the compressor 32, an external pressurized fluid source, such as a canister or pump, or any other suitable source of fluid that is pressurized relative to a pressure of an annular chamber in which the lip seal 126 is disposed. For example, in embodiments in which the compressor 32 circulates water as a working fluid, vaporized water (e.g., steam) may be directed from an evaporator to the compressor 32, and the compressor 32 may compress the steam and discharge the steam to a condenser. A portion of the steam pressurized by the compressor 32 may be utilized as the pressurized fluid 132. In certain cases, the steam may undergo multiple stages of compression before the generated steam is sufficiently pressurized relative to the annular chamber in which the lip seal 126 is disposed. For example, a pressure of the steam within the compressor 32 may be below atmospheric pressure, which may be insufficient to disengage the lip seal 126 from the rotor shaft 106 when the pressurized fluid 132 is directed toward the lip seal 126. Accordingly, in certain embodiments, the steam may first be directed through one or more additional stages of compression such that the steam reaches a pressure that is greater than a desired threshold pressure (e.g., pressure greater than atmospheric pressure), thereby enabling the steam to lift the lip seal 126 away from the rotor shaft 106, as described in greater detail below. In other embodiments, the pressurized fluid 132 may be provided by an external pressurized source having a pump configured to pressurize the pressurized fluid 132 to a desired pressure before directing the pressurized fluid 132 toward the lip seal 126.

In the present embodiment, the pressurized fluid 132 travels through the injection pathway 134 defined or machined into the housing 101. The injection pathway 134 may extend between the pressurized fluid source 130 and an annular chamber in which the lip seal 126 is disposed. Thus, the pressurized fluid 132 may flow through the injection pathway 134 and through an orifice of the annular chamber to pressurize the annular chamber in which the lip seal 126 is disposed, such that a pressure that effectively lifts (e.g., disengages) the lip seal 126 from the rotor shaft 106 may be selectively applied to the lip seal 126. As such, the sealing system 120 may apply the pressurized fluid 132 to the lip seal 126 to selectively lift the lip seal 126 from contact with the rotor shaft 106 (e.g., to transition the lip seal 126 to the first configuration). Indeed, because the lip seal 126 may lift away from the outer surface 128 of the rotor shaft 106 in response to the pressurized fluid 132, the lip seal 126 may be considered a “reverse” lip seal, in contrast to traditional lip seals that may be biased against a rotor shaft in response to application of a pressurized fluid.

During operation of the compressor 32, the rotor shaft 106 may rotate at various rotation rates or speeds about the circumferential axis 204 and relative to the housing 101 to power or drive the rotor 33, and thus the impeller 108, of the compressor 32. For example, based on control signals received from the control panel 40 or another suitable control device or system, the motor 50 may ramp up in rotation rate of the rotor shaft 106 from a resting state corresponding to zero revolutions per minute (RPM) to an activated state corresponding to approximately 500 RPM, 1000 RPM, 2500 RPM, 5000 RPM, and/or another suitable speed. In other words, the motor 50 may ramp up in speed of the rotor shaft 106 from a resting state corresponding to zero meters per second (m/s) to approximately 50 m/s, 75 m/s, 90 m/s, and/or another suitable speed. As noted above, in certain embodiments, the rotation rate or speed of the compressor 32 (e.g., the rotor shaft 106) may be dependent upon the type of working fluid (e.g., working fluid) directed through the vapor compression system 14. For example, in embodiments in which water is used as the working fluid, the compressor 32 may be configured to operate at higher rotation rates or shaft seal surface speeds (e.g., 15,000 RPM, 25,000 RPM, 45,000 RPM, 100 m/s, 115 m/s, 130 m/s) to desirably compress the water and direct the water through the vapor compression system 14. However, operating the compressor 32 at such rotation rates and/or speeds may result in wear and degradation on components of the sealing system 120.

Accordingly, to operate the compressor 32 with a rotation rate or speed above a threshold rotation rate or threshold speed (e.g., above a design threshold rotation rate of the sealing system 120 and/or lip seal 126, above a design threshold rotation speed of the sealing system 120 and/or lip seal 126), the pressurized fluid 132 may be selectively directed (e.g., via a signal from the control panel 40) through the injection pathway 134 to lift the lip seal 126 off of the rotating rotor shaft 106, thereby enabling the rotor shaft 106, and thus the compressor 32, to rotate at higher speeds while limiting an amount of wear and degradation to the lip seal 126 (e.g., via reduced contact between the lip seal 126 and the rotor shaft 106 during rotation of the rotor shaft 106). The pressurized fluid 132 that flows across and/or past the lip seal 126 may proceed to flow toward an exit pathway 136 (e.g., exit port, fluid outlet, discharge port) formed (e.g., machined) into the housing 101 and configured to direct the pressurized fluid 132 out of the housing 101. For example, the exit pathway 136 may direct the pressurized fluid 132 to the atmosphere via an outlet 138 of the exit pathway 136 (e.g., of the housing 101). The exit pathway 136 may be fluidly coupled to the injection pathway 134 and may be positioned downstream of the injection pathway 134 relative to a flow direction of pressurized fluid 132 through the sealing system 120. In this way, an amount of the pressurized fluid 132 present within the housing 101 may be limited, which may be desirable, as discussed in greater detail below.

As noted above, in certain embodiments, water may be utilized as a working fluid, and water vapor (e.g., steam) may be utilized as the pressurized fluid 132 supplied to the compressor 32 (e.g., the injection pathway 134) to selectively lift the lip seal 126 from the rotor shaft 106 during an operative mode of the compressor 32 (e.g., during rotation of the rotor shaft 106). However, presence of the pressurized fluid 132 (e.g., steam) within the housing 101 (e.g., within the motor housing portion 104 of the housing 101) may reduce the efficiency of the motor 50 and/or increase wear and degradation on components of the motor 50. Accordingly, in certain embodiments, the compressor system 100 may have an open design (e.g., as opposed to hermetic or semi-hermetic compressor design), such that the motor 50 is vented with air and separated from the compressor 32 via the housing 101 (e.g., via the compressor housing portion 102 and the motor housing portion 104). For example, the motor housing portion 104 may be cooled by a pressurized air flow that is forced into the motor housing portion 104 (e.g., via a fan or blower), which in turn, creates a pressure rise within the motor housing portion 104. In certain embodiments, the pressure within the motor housing portion 104 may be maintained at a pressure slightly above atmospheric pressure (e.g., using the pressurized air from an air source). During operation of the compressor 32, the pressurized fluid 132 (e.g., steam) may be directed through the injection pathway 134 and toward the exit pathway 136 that is fluidly coupled to the atmosphere via the outlet 138. The outlet 138 may be sized such that a pressure at the outlet 138 is at or near atmospheric pressure (e.g., 1 bar). Because the pressure of the motor housing portion 104 is maintained at a pressure above atmospheric pressure (e.g., via supply of cooling air into the motor housing portion 104) and because the pressure of the pressurized fluid 132 is greater than the atmospheric pressure, as the pressurized fluid 132 (e.g., steam) is directed through the injection pathway 134 and past the lip seal 126, the pressurized fluid 132 may flow toward the exit pathway 136 and out of the outlet 138 (e.g., as the pressurized fluid 132 follows a path of least resistance), thereby enabling removal of the pressurized fluid 132 from the housing 101. In certain embodiments, the pressure of the cooling, pressurized air flow within the motor housing portion 104 may be higher than the pressure of the pressurized fluid 132, thereby blocking the pressurized fluid 132 from entering into the motor housing portion 104. However, in embodiments in which the pressure of the cooling, pressurized air flow is less than the pressure of the pressurized fluid 132, the pressurized fluid 132 may nonetheless be blocked from entering the motor housing portion 104 because the size of the outlet 138 enables the pressurized fluid 132 to take the path of least resistance out of the housing 101.

Furthermore, during an operative mode of the compressor 32, as the pressurized fluid 132 flows through the injection pathway 134 and lifts the lip seal 126 from the rotor shaft 106, the pressure and flow direction of the pressurized fluid 132 through the injection pathway 134 may block other fluids (e.g., pressurized air from the motor housing portion 104) from flowing in a direction opposite the flow direction of the pressurized fluid 132. For example, pressurized air from the motor housing portion 104 may be blocked from entering the compressor 32 (e.g., compressor housing portion 102) through the injection pathway 134 due to the pressure and flow direction of the pressurized fluid 132 flowing through the injection pathway 134.

During an idle or standby mode of the compressor 32, the rotor shaft 106 may not rotate, and pressurized fluid 132 may no longer be directed from the pressurized fluid source 130 through the injection pathway 134 toward the lip seal 126 (e.g., based on a control signal from the control panel 40). In turn, the lip seal 126 may return to a resting state in which the lip seal 126 is engaged with the outer surface 128 of the rotor shaft 106 (e.g., due to the inherent elasticity of the lip seal 126). Because the rotor shaft 106 and the compressor 32 may no longer be rotating during an idle mode of the compressor 32, the saturation temperature of fluid within the compressor 32 may decrease, which may cause working fluid vapor within the compressor 32 to condense into a working fluid liquid. For example, in embodiments in which water is used as a working fluid, as the saturation temperature of the fluid within the compressor 32 decreases due to the compressor 32 being inoperative (e.g., inactive, not rotating), water vapor (e.g., steam) may begin to condense into liquid water. As noted above, the presence of water and/or steam within the motor housing portion 104 of the housing 101 may be undesirable. However, because the pressurized fluid 132 may no longer be injected into the injection pathway 134 during the idle or standby mode of the compressor 32, the lip seal 126 may transition to the second configuration in which the lip seal 126 is engaged with the outer surface 128 of the rotor shaft 106, thereby blocking condensed working fluid (e.g., liquid water) from traveling across the lip seal 126 and toward (e.g., into) the motor housing portion 104 of the housing 101. In this way, an amount of fluid migration (e.g., condensed working fluid) from the compression side of the compressor 32 to the motor cavity of the motor 50 (e.g., from the compressor housing portion 102 to the motor housing portion 104) may be limited, thereby reducing costs associated with wear and degradation of the motor 50.

Additionally, during the idle mode of the compressor 32, as the working fluid vapor condenses (e.g., as a result of the saturation temperature of fluid within the compressor 32 decreasing), the pressure within the compressor 32 may also decrease and a negative pressure vacuum may be created on the compression side, which may cause non-condensable air within the motor housing portion 104 to be drawn into the compressor 32 (e.g., compression side), which may also be undesirable. However, because pressurized fluid 132 is not directed through the injection pathway 134 toward the lip seal 126, the lip seal 126 may engage with (e.g., contact) the outer surface 128 of the rotor shaft 106, thereby blocking non-condensable air from traveling across the lip seal 126 and into the compressor 32 (e.g., compression side, into the compressor housing portion 102). Further, because the lip seal 126 is engaged with the outer surface 128 of the rotor shaft 106, as the pressure within the compressor 32 continues to decrease, the magnitude of a negative pressure or vacuum within the compressor 32 may increase, which may generate a pulling force on the lip seal 126 that draws the lip seal 126 toward the rotor shaft 106 and reinforces a sealing engagement between the lip seal 126 and the rotor shaft 106.

Furthermore, as the working fluid within the compressor 32 condenses, the pressure within the compressor 32 may continue to decrease until the pressure within the compressor 32 is less than an atmospheric pressure surrounding the compressor system 100. Because the pressure within the compressor 32 is less than the atmospheric pressure and/or less than a pressure within the motor housing portion 104 (e.g., which as noted above, may be maintained slightly above atmospheric pressure via pressurized air injected into the motor housing portion 104), air from the motor housing portion 104 and/or ambient air from the environment may impinge (e.g., push) against the lip seal 126, thereby reinforcing the sealing engagement between the lip seal 126 and the outer surface 128 of the rotor shaft 106. In this way, during an idle or standby mode of the compressor 32, non-condensable air from the motor housing portion 104 may be blocked from passing across the lip seal 126 and flowing into the compressor 32 (e.g., into the compressor housing portion 102, into the compression side), while condensed liquid working fluid from the compressor 32 (e.g., from the compressor housing portion 102) may be blocked from passing across the lip seal 126 and into the motor housing portion 104 (e.g., into the motor cavity of the motor 50).

In certain embodiments, the compressor 32 may include one or more sensors 210 configured to detect various operating parameters and/or operating conditions of the compressor 32. For example, the one or more sensors 210 may be disposed throughout the compressor 32 and may be configured to detect data indicative of an operating mode of the compressor (e.g., whether the compressor 32 is in an operative mode or an idle or standby mode), a temperature, a pressure, and/or a flow rate of working fluid through the compressor 32, a rotational rate of the compressor 32 (e.g., rotational rate of an impeller of the compressor 32), and the like. The one or more sensors 210 may communicate such data to a controller 220 (e.g., control panel 40, control system, automation controller), thereby enabling the controller 220 to control operation of the pressurized fluid source 130 (e.g., thereby enabling the controller 220 to transition the lip seal 126 between the first configuration and the second configuration). That is, in certain embodiments, certain components of the compressor 32 may be communicatively coupled to the controller 220 (e.g., control panel 40), thereby enabling the controller 220 to control operation of the compressor 32 and/or the sealing system 120 (e.g., lip seal 126, pressurized fluid source 130), as described in greater detail below.

In certain embodiments, the controller 220 may include processing circuitry 222 (e.g., one or more microprocessors) and a memory 224. For example, the controller 220 may include non-transitory code or instructions stored in a machine-readable medium (e.g., the memory 224) that is used by the processing circuitry 222 to implement the techniques disclosed herein. The memory 224 may include volatile memory, such as read-only memory (ROM), optical drives, hard disc drives, solid-state drives, or any other non-transitory, computer-readable medium storing instructions that, when executed by the processing circuitry 222, control operation of the vapor compressor 32 and/or the sealing system 120. The controller 220 may monitor and control operation of the sealing system 120, for example, by controlling operation of the pressurized fluid source 130. In certain embodiments, the controller 220 may control operation of the pressurized fluid source 130 based on feedback received from the one or more sensors 210. For example, upon receiving sensor data indicative of the compressor 32 transitioning to an idle or standby mode, the controller 220 may control the pressurized fluid source 130 to stop directing pressurized fluid 132 toward the lip seal 126 of the sealing system 120. Conversely, upon detecting that the compressor 32 is in an operative mode (e.g., via data from the one or more sensors 210), the controller 220 may activate the pressurized fluid source 130 to direct pressurized fluid 132 through the injection pathway 134 and toward the lip seal 126. That is, the controller 220 may control operation of the pressurized fluid source 130 to selectively transition the lip seal 126 between the first configuration and the second configuration. In this way, operation of the compressor 32 at high speeds may be achievable, while an amount of fluid migration between the compressor 32 and the motor cavity of the motor 50 (e.g., between the compressor housing portion 102 and the motor housing portion 104) is limited. It should be appreciated that in certain embodiments, the controller 220 may control operation of the sealing system 120 based on a manual input provided via an operator associated with the compressor 32.

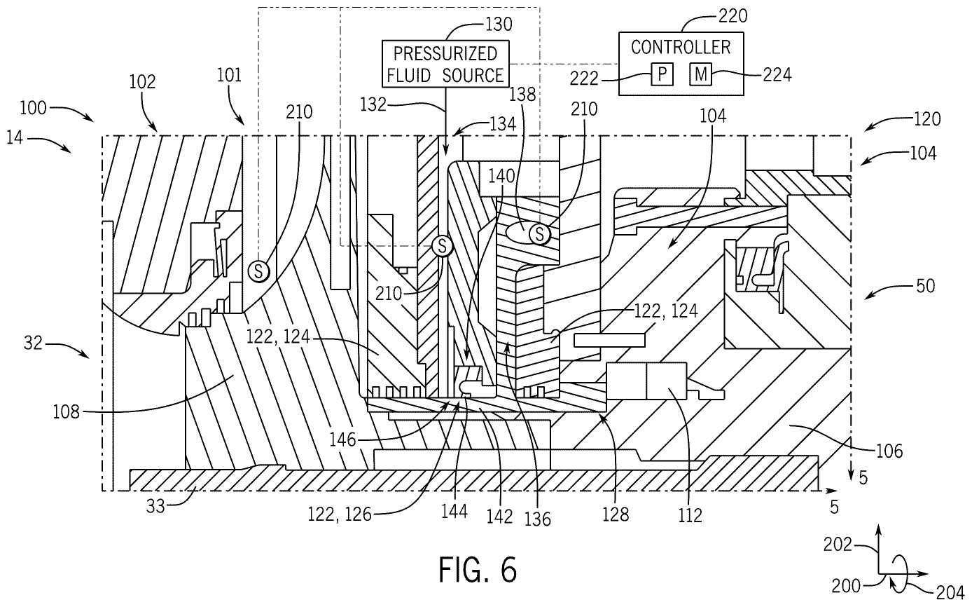

FIG. 6 is a cross-sectional side view of a portion of the compressor system 100, taken within dashed line 5-5 of FIG. 5, illustrating an embodiment of the sealing system 120. As shown in FIG. 6, the lip seal 126 is disposed within an annular chamber 140 defined between walls (e.g., inner housing walls) of the housing 101 and the outer surface 128 of the rotor shaft 106. In certain embodiments, a sleeve 142 may be positioned about the rotor shaft 106, and the lip seal 126 may engage with the sleeve 142 to limit fluid migration across the lip seal 126 during an idle mode of the compressor 32. However, it should be noted that in certain embodiments, the sleeve 142 may be omitted and the lip seal 126 may be configured to directly contact the outer surface 128 of the rotor shaft 106 during the idle mode of the compressor 32 and/or lift from the outer surface 128 of the rotor shaft 106 during an operative mode of the compressor 32. The lip seal 126 may include a sealing portion 144 formed of a flexible material that enables the sealing portion 144 to be biased against the sleeve 142 (or the outer surface 128 of the shaft 106). As such, when the rotor shaft 106 is at rest or still, the sealing portion 144 applies force to the sleeve 142, thus limiting an amount of fluid migration from the compression side of the compressor 32 to the motor cavity of the motor 50 and/or from the motor cavity to the compression side of the compressor 32, as described above.

Additionally, as noted above, the sealing system 120 includes the pressurized fluid source 130 configured to direct pressurized fluid 132 toward a back surface 146 (e.g., rear surface, convex surface) of the lip seal 126. For example, the pressurized fluid 132 may travel through the injection pathway 134 toward the annular chamber 140 to pressurize a space between the annular chamber 140 and the back surface 146 of the lip seal 126. By controlling flow of the pressurized fluid 132 to the annular chamber 140 (e.g., via a control signal sent from the controller 220), pressure may be selectively applied to the back surface 146 of the lip seal 126 to control lifting of the sealing portion 144 of the lip seal 126 from the sleeve 142. As the sealing portion 144 of the lip seal 126 lifts from the sleeve 142, the pressurized fluid 132 may be directed toward the exit pathway 136 and eventually to the atmosphere via the outlet 138. For example, as noted above, the outlet 138 may be sized such that a pressure differential at the outlet 138 drives the pressurized fluid 132 through the exit pathway 136 and out of the outlet 138 (e.g., by taking the path of least resistance). In this way, the pressurized fluid 132 may be blocked from entering the motor housing portion 104 and interacting with components of the motor 50. Additionally, in certain embodiments, pressurized air may be directed into the motor housing portion 104 to cool components of the motor 50 and to maintain a pressure within the motor housing portion 104 above atmospheric pressure. In doing so, pressurized fluid 132 directed through the injection pathway 134 may be blocked from entering the motor housing portion 104 by the pressurized air within the motor housing portion 104, and instead may be forced toward the exit pathway 136 and out of the outlet 138 to be discharged from the compressor system 100. As such, wear and degradation from the pressurized fluid 132 interacting with components of the motor 50 may be reduced, thereby limiting unscheduled maintenance and replacement costs associated with the compressor system 100.

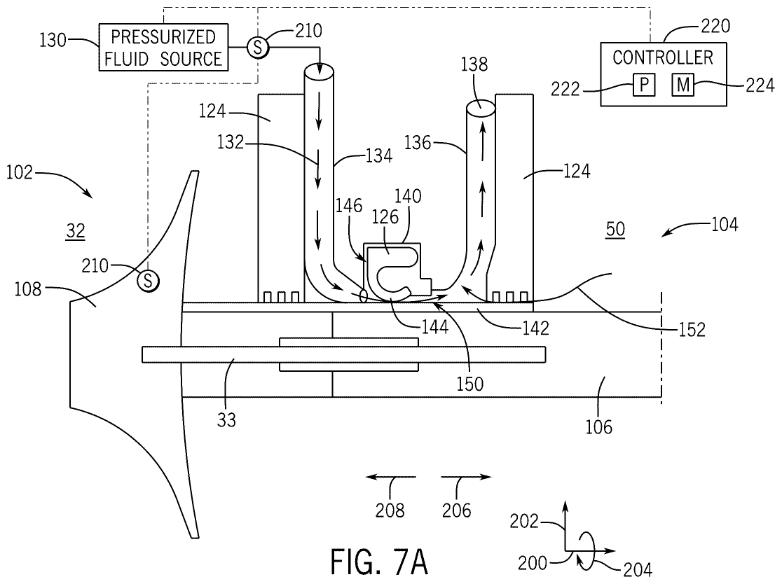

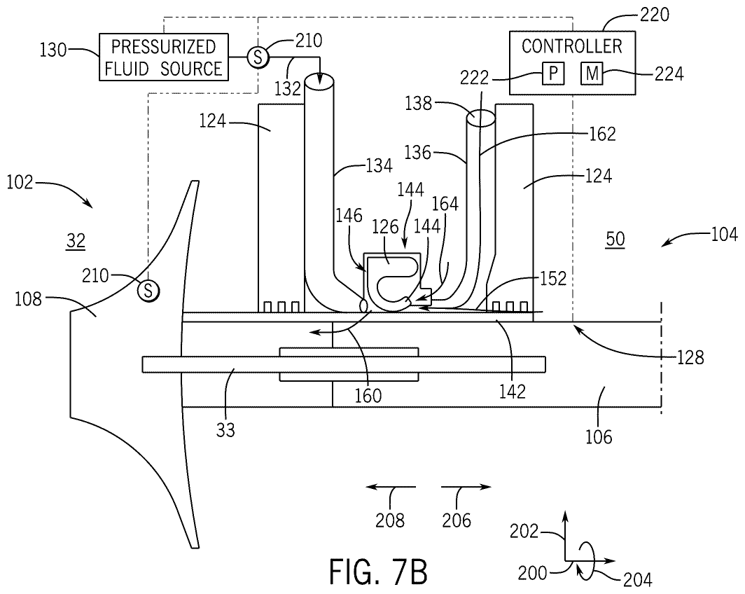

FIGS. 7A and 7B are schematic views of embodiments of the sealing system 120, illustrating various forces generated on the components of the sealing system 120 and the various fluid flows within the compressor system 100 during different operating modes of the compressor system 100. For example, FIG. 7A illustrates various forces and fluid flows within the compressor system 100 when the compressor 32 is in an operative mode, and FIG. 7B illustrates various forces and fluid flows of the compressor system 100 when the compressor 32 is in an idle or standby mode.

Turning to FIG. 7A, during an operative mode of the compressor system 100 (e.g., as detected by the one or more sensors 210), the controller 220 may send a signal to the pressurized fluid source 130 to direct the pressurized fluid 132 into the injection pathway 134 and toward the lip seal 126. As noted above, the pressurized fluid 132 may be directed (e.g., within the annular chamber 140) in a direction 206 (e.g., direction toward motor 50) along the longitudinal axis 200 toward the back surface 146 of the lip seal 126, and the pressurized fluid 132 may generate a lifting force 150 that causes the sealing portion 144 of the lip seal 126 to lift away from the sleeve 142. As a result, the rotor shaft 106 may be rotated at increased speeds while an amount of wear and degradation caused by interaction between the rotor shaft 106 and the lip seal 126 may be reduced. Further, as the pressurized fluid 132 is directed through the injection pathway 134, pressurized air 152 within the housing 101 (e.g., within the motor housing portion 104) may be limited from traveling in a direction 208 (e.g., direction toward compressor 32) opposite the direction 206 from the motor housing portion 104 and into the compressor housing portion 102 (into the compression side of the compressor 32). For example, in certain embodiments, the pressure at which the pressurized fluid 132 travels through the injection pathway 134 may be slightly greater than the pressure of the pressurized air 152 within the housing 101. As a result, the pressurized fluid 132 blocks pressurized air 152 in the motor housing portion 104 from entering the compressor housing portion 102 (e.g., by flow across the lip seal 126), and instead directs the pressurized fluid 132 and/or the pressurized air 152 along the exit pathway 136 toward the outlet 138 fluidly coupled to the atmosphere. In this way, as the compressor 32 is operated, the motor housing portion 104 may remain substantially free of any pressurized fluid 132 (e.g., steam), while the compressor housing portion 102 may remain substantially free of any pressurized air 152 from the motor housing portion 104.

Turning to FIG. 7B, during an idle or standby mode of the compressor system 100 (e.g., as detected by the one or more sensors 210), the controller 220 may send a signal to the pressurized fluid source 130 to stop the supply of the pressurized fluid 132 into the injection pathway 134. As noted above, because the compressor 32 is inoperative during an idle mode, the saturation temperature of fluid within the compressor 32 may decrease, thereby causing working fluid within the compressor 32 to condense. For example, in embodiments in which the compressor 32 circulates water as a working fluid, water vapor (e.g., steam) within the compressor 32 may condense to liquid water as the saturation temperature of the fluid within the compressor 32 decreases. Thus, when the compressor 32 is idle and the pressurized fluid source 130 does not supply the pressurized fluid 132 to the compressor 32, the lip seal 126 may engage with the sleeve 142 (or the outer surface 128 of the rotor shaft 106) by virtue of the radial stiffness and/or elasticity of the lip seal 126 and also by virtue of the increasing pressure differential between the compressor 32 and the atmosphere due to the working fluid (e.g., water vapor, steam) condensing within the compressor 32. For example, as noted above, a negative pressure or vacuum may be created within the compressor 32 due to the decrease in pressure within the compressor 32 (e.g., within the compressor system 100) from the working fluid condensing, thereby generating a pulling force 160 on the back surface 146 of the lip seal 126 in the direction 208. The pulling force 160 reinforces a sealing engagement of the lip seal 126 with the sleeve 142 and/or rotor shaft 106. Additionally, in certain embodiments, as the pressure within the compressor 32 decreases as the working fluid condenses, the pressurized air 152 within the motor housing portion 104 and/or ambient air 162 surrounding the compressor system 100 (e.g., directed through the exit pathway 136 via the outlet 138) may provide a pushing force 164 in the direction 208 that further reinforces sealing engagement of the lip seal 126 with the sleeve 142. In this way, the lip seal 126 limits an amount of non-condensable air from entering the compressor 32, thereby reducing potential wear and degradation on components of the compressor 32. Further, by limiting an amount of air entering the compressor 32, a purging process to remove air from the compressor system 100 prior to starting the compressor system 100 may be avoided, thereby increasing efficiency and reducing costs associated with operation of the compression section 100.

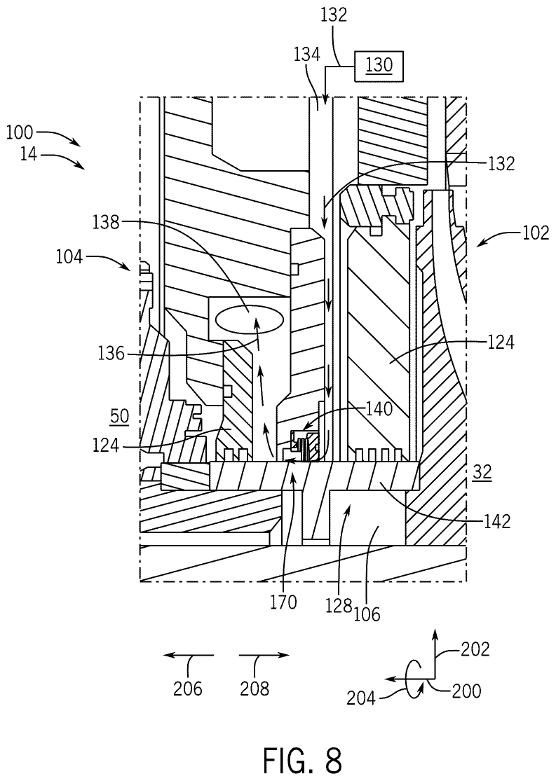

FIG. 8 is a cross-sectional side view of an embodiment of the compressor system 100 of the vapor compression system 14 having a dovetail seal 170 (e.g., axial floating gasket), which may be utilized (e.g., as a component of the sealing system 120) instead of a lip seal. As illustrated, the compressor system 100 may include several features that are similar to the embodiment of the compressor system 100 having the lip seal 126. Indeed, the dovetail seal 170 may function substantially similar to the lip seal 126 of FIG. 5 discussed above. For example, during an operative mode of the compressor system 100, the pressurized fluid source 130 may direct the pressurized fluid 132 toward the dovetail seal 170 via the injection pathway 134. As the pressurized fluid 132 is directed through the injection pathway 134 toward the dovetail seal 170, the pressurized fluid 132 may engage with a floating ring of the dovetail seal 170 and may push the floating ring and an associated gasket radially away from the sleeve 142 (or the outer surface 128 of the rotor shaft 106), thereby causing the dovetail seal 170 to disengage (e.g., lift) from the sleeve 142. As the dovetail seal 170 is disengaged from the sleeve 142 and/or the rotor shaft 106, friction and heat losses as a result of contact of the dovetail seal 170 with the rotor shaft 106 may be reduced or eliminated, thereby enabling the rotor shaft 106 to be rotated at increased speeds (e.g., speeds greater than a design speed of the sealing system 120). Further, because the pressurized fluid 132 is directed in the direction 206 along the longitudinal axis 200, another fluid within the compressor system 100 (e.g., from the motor 50) is blocked from traveling in the direction 208 opposite the direction 206 in which the pressurized fluid 132 flows. In this way, as the compressor 32 is operated, pressurized air 152 from the motor housing portion 104 may be blocked from traveling in the direction 208 into the compressor 32 (e.g., into the compressor housing portion 102). Further, similar to the embodiments above, the pressurized fluid 132 may flow along a path of least resistance and may be directed through the injection pathway 134, toward the exit pathway 136, and into the atmosphere via the outlet 138, thereby limiting an amount of pressurized fluid 132 from entering the motor housing portion 104 and interacting with the components of the motor 50.

During an idle mode of the compressor 32, the controller 220 may send a signal to stop directing pressurized fluid 132 toward the dovetail seal 170. Similar to the lip seal 126 discussed above, the dovetail seal 170 may be made of suitable material having elastic properties and a resting geometry that enables the dovetail seal 170 to sealingly engage with the sleeve 142 (or the outer surface 128 of the rotor shaft 106) when no pressurized fluid 132 is directed through the injection pathway 134. In certain embodiments, the dovetail seal 170 may include a spring configured to bias the dovetail seal 170 into engagement with the sleeve 142 (or the outer surface 128 of the rotor shaft 106). However, during an operative mode of the compressor 32, the force applied by the spring may be overcome by directing the pressurized fluid 132 through the injection pathway 134, thereby enabling the dovetail seal 170 to disengage from the rotor shaft 106. Further, as noted above, when the compressor 32 is inoperative, the saturation temperature of fluid within the compressor 32 may decrease, which in turn, may cause the working fluid within the compressor 32 to condense. As the working fluid condenses, the pressure within the compressor 32 may also decrease, thereby creating a negative pressure or vacuum within the compressor 32. This negative pressure or vacuum may reinforce sealing engagement of the floating ring and gasket of the dovetail seal 170 with the rotor shaft 106, thereby limiting an amount of fluid migration between the compression side of the compressor 32 and the motor cavity of the motor 50 (e.g., between the compressor housing portion 102 and the motor housing portion 104), as discussed herein. In this way, wear and degradation on components of the compressor system 100 may be reduced. Further, startup times may be reduced as reduced amounts of air within the compressor 32 may avoid utilization of a purging process in the compressor 32 before startup. In this way, operating costs may be reduced and operating efficiency of the vapor compression system 14 may be increased.

As set forth above, the present disclosure may provide one or more technical effects useful in operating compressors that are configured to circulate water as a working fluid. Embodiments of the disclosure may include sealing elements that are selectively liftable from a rotor shaft of a motor in response to a pressurized fluid from a pressurized fluid source during an operative mode of the compressor.

In this way, the compressor may be operated at increased speeds, thereby enabling the compressor to effectively compress the water as a working fluid. During an idle mode of the compressor, the sealing elements may reengage with the rotor shaft, thereby limiting an amount of fluid migration from a motor housing into the compressor and from the compressor into the motor housing. In this way, wear and degradation on components of both the compressor and the motor may be reduced, thereby decreasing maintenance and repair costs. The technical effects and technical problems in the specification are examples and are not limiting. It should be noted that the embodiments described in the specification may have other technical effects and can solve other technical problems.

While only certain features and embodiments have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described (i.e., those unrelated to the presently contemplated best mode of carrying out the disclosure, or those unrelated to enabling the claimed disclosure). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A compressor system, comprising:
a housing comprising an impeller disposed therein;
a motor disposed within the housing, wherein the motor comprises a rotor shaft coupled to the impeller, and the motor is configured to drive rotation of the rotor shaft and the impeller; and
a sealing system disposed within the housing, wherein the sealing system comprises a sealing element circumferentially disposed around the rotor shaft and configured to bias against a surface of the rotor shaft in a first configuration,
wherein the housing comprises an injection port formed therein, wherein the injection port is configured to direct a pressurized fluid into the housing to impinge against the sealing element to transition the sealing element from the first configuration to a second configuration, and wherein the sealing element is lifted away from the surface of the rotor shaft in the second configuration.

2. The compressor system of claim 1, comprising a controller configured to control operation of a pressurized fluid source to direct the pressurized fluid to the injection port during an active operating mode of the compressor.

3. The compressor system of claim 2, wherein the controller is configured to control operation of the pressurized fluid source to suspend supply of the pressurized fluid to the injection port during an idle mode of the compressor system.

4. The compressor system of claim 1, wherein the sealing element comprises a lip seal.

5. The compressor system of claim 4, wherein the lip seal comprises a flexible material, and the lip seal is configured to bias against the surface of the rotor shaft in a resting state of the lip seal.

6. The compressor system of claim 4, wherein the lip seal comprises a convex surface, and wherein the convex surface faces the injection port, such that the pressurized fluid directed into the housing impinges against the convex surface of the lip seal.

7. The compressor system of claim, wherein the sealing system comprises a first labyrinth seal and a second labyrinth seal, the first labyrinth seal and the second labyrinth seal are each configured to create a respective sealing interface with the surface of the rotor shaft, and the lip seal is disposed between the first labyrinth seal and the second labyrinth seal relative to a longitudinal axis of the compressor system.

8. The compressor system of claim 7, wherein each of the first labyrinth seal and the second labyrinth seal comprises a sealing extension having a T-shaped cross section with a toothed surface.

9. The compressor system of claim 1, wherein the housing defines a compressor housing portion and a motor housing portion, the impeller is disposed within the compressor housing portion, the motor is disposed within the motor housing portion, and the motor housing portion is configured receive and direct a cooling air flow therethrough.

10. The compressor system of claim 7, wherein the sealing element is configured to create a sealing engagement with the surface of the rotor shaft in the first configuration, and the sealing element is configured to block fluid migration between the compressor housing portion and the motor housing portion in the first configuration.

11. The compressor system of claim 1, wherein the housing comprises an exit port formed therein, wherein the exit port is configured to direct the pressurized fluid out of the housing.

12. The compressor system of claim 1, wherein the exit port is configured to discharge the pressurized fluid to an atmosphere surrounding the compressor system.

13. A heating, ventilation, air conditioning, and refrigeration (HVAC&R) system, comprising:
a compressor configured to compress a working fluid and circulate the working fluid through a working fluid circuit;
a motor coupled to the compressor via a rotor shaft and configured to drive operation of the compressor via rotation of the rotor shaft; and
a sealing system configured to limit fluid migration between the motor and the compressor, wherein the sealing system comprises a sealing element configured to transition from a first configuration to a second configuration based on operation of a pressurized fluid source fluidly coupled to the sealing element, wherein a sealing portion of the sealing element is configured to engage with a surface of the rotor shaft in the first configuration, and wherein the sealing portion of the sealing element is configured to disengage from a surface of the rotor shaft in the second configuration.

14. The HVAC&R system of claim 13, wherein the working fluid is water, the HVAC&R system comprises an evaporator disposed along the vapor compression circuit and configured to place the water in a heat exchange relationship to generate steam, and wherein the compressor is configured to direct a portion of the steam toward the pressurized fluid source to be used as the pressurized fluid.

15. The HVAC&R system of claim 14, wherein the compressor is configured to pressurize the steam via one or more stages of compression before directing the steam to the pressurized fluid source.

16. A sealing system for a motor of a compressor, comprising:
a sealing element circumferentially disposed around a rotor shaft of the motor and configured to transition between a first configuration and a second configuration, wherein the sealing element comprises a sealing portion configured to:
disengage from an outer surface of the rotor shaft in the first configuration; and
contact the outer surface of the rotor shaft in the second configuration;
a pressurized fluid source configured to provide a pressurized fluid, wherein the sealing element is configured to transition from the second configuration to the first configuration in response to the pressurized fluid source providing the pressurized fluid; and
a controller configured to control operation of the pressurized fluid source to transition the sealing element between the first configuration and the second configuration in response to a detected operational state of the compressor.

17. The sealing system of claim 16, wherein the controller is configured to:
initiate the operation of the pressurized fluid source to transition the sealing element to the first configuration based on the detected operational state of the compressor corresponding to an operative mode; and
stop the operation of the pressurized fluid source to transition the sealing element to the second configuration based on the detected operational state of the compressor corresponding to an idle mode.

18. The sealing system of claim 17, wherein the sealing system is configured to:
limit a first amount of fluid migration from the motor to the compressor during the operative mode of the compressor;
limit a second amount of fluid migration from the motor to the compressor during the idle mode of the compressor; and
limit a third amount of fluid migration from the compressor to the motor during the idle mode of the compressor.

19. The sealing system of claim 16, comprising one or more sensors configured to detect data indicative of an operating mode of the compressor, wherein the controller is configured to control the operation of the pressurized fluid source based on the data from the one or more sensors.

20. The sealing system of claim 19, wherein the controller is configured to:
initiate the operation of the pressurized fluid source to transition the sealing element to the first configuration based on the data from the one or more sensors indicating that the compressor is in an operative mode; and
stop the operation of the pressurized fluid source to transition the sealing element to the second configuration based on the data from the one or more sensors indicating that the compressor is in an idle mode.
